(19) United States
(12) Patent Application Publication
(10) Pub. No.: US 2005/0160616 A1
(43) Pub. Date: Jul. 28, 2005

(54) Multi-format spindle transport device for transporting and cooling flat substrates

(75) Inventors: Michael Menk, Hebertshausen (DE); Anton Geissler, Eching (DE); Klaus Peter Weidenhaupt, Munchen (DE); Josef Krimmer, Markt Indersdorf (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 11/034,220

(22) Filed: Jan. 12, 2005

Related U.S. Application Data
(63) Continuation of application No. PCT/EP03/07385, filed on Jul. 9, 2003.

(30) Foreign Application Priority Data
Jul. 13, 2002 (DE) 102 31 767.4

(51) Int. Cl. F26B 11/00

(52) U.S. Cl. 34/184

(57) ABSTRACT

A multi-format spindle transport device for transporting and cooling flat substrates, in particular data carriers that can be optically read includes four spindles arranged in parallel relationship in a spindle holder, and a drive for rotating the spindles. The spindle holder is configured in such a way that the relative spatial arrangement of the spindles in relation to one another can be adjusted, so that substrates of different formats can be engaged simultaneously by all four spindles.

### CROSS-REFERENCES TO RELATED APPLICATIONS

This application is a continuation of prior filed copending PCT International application no. PCT/EP2003/007385, filed Jul. 9, 2003, which designated the United States and on which priority is claimed under 35 U.S.C. §120, and which claims the priority of German Patent Application, Serial No. 102 31 767.4, filed Jul. 13, 2002, pursuant to 35 U.S.C. 119(a)-(d.

### BACKGROUND OF THE INVENTION

The present invention relates to a multi-format spindle transport device for transporting and cooling flat substrates, in particular optically readable data carriers such as, for example, CD, CD-R, CD single, DVD, DVD single as well as different formats of optically readable business cards according to the preamble of claim 1.

Nothing in the following discussion of the state of the art is to be construed as an admission of prior art.

The production of optically readable data carriers of the above-mentioned type involves the use of an injection molding machine to make blanks from plastic pellets, typically polycarbonates, which blanks are then processed in further steps until a finished CD, CD-R, DVD, etc. is obtained at the end of the production line. After exiting the injection molding machine, the blanks are still hot and must be cooled down before being treated further. Typically, the temperature is at about 100° C., when removed from the injection molding machine and placed into the multi-format spindle transport device. During transport through the multi-format spindle transport device, the blank cools down as a result of radiation and possible additional cooling measures. For example, a fan may be provided to produce a laminar air flow upon the surface of the blanks. When removed from the multi-format spindle transport device, the blank should have a process temperature of about 22° C.

Known spindle transport devices using spindles to transport blanks along a cooling zone include three spindles disposed in symmetric and parallel relationship and each having a thread turn and a particular thread undercut width. Such a spindle transport device is disclosed, for example, in European patent publication no. EP 1 100 080 A2. Disadvantageous is here however that a change of production, for example from CD to DVD or from CD to DVD single requires modification of the present spindle transport device or replacement with another transport device to receive blanks of different thickness or different diameter.

German patent publication no. DE 100 28 399 discloses a spindle transport device which is able to process CD blanks as well as DVD blanks, without requiring any modification, and includes four spindles arranged non-symmetrically to one another for transport of CD and DVD blanks as well as CD and DVD single blanks.

Substrates having non-circular outer contour, such as, for example, DVD cards known from Japanese publication JP 2002170286 A or with diameters deviating from standardized diameters for CDs and DVDs or their singles cannot be transported however by a spindle transport device of this type.

It would therefore be desirable and advantageous to provide an improved multi-format spindle transport device to obviate prior art shortcomings and to allow operation with essentially all data carrier formats.

### SUMMARY OF THE INVENTION

According to one aspect of the present invention, a multi-format spindle transport device for transporting and cooling flat substrates, in particular optically readable data carriers, includes a spindle holder, four spindles disposed in the spindle holder in parallel relationship, and a drive for rotating the spindles, wherein the spindle holder is constructed to allow adjustment of a relative spatial arrangement of the spindles relative to one another such that substrates of varying formats can be brought into engagement with all four spindles at a same time.

Keeping the spindle transport principle is advantageous for space-saving reasons because a greatest possible number of substrates can be stored in small space.

The present invention resolves prior art problems by providing flexibility of the multi-format spindle transport device to suit almost all data carrier formats. Modification of the production to another format thus no longer requires an exchange of the spindle transport device. As a result, the multi-format spindle transport device according to the invention is universally applicable.

As the spindle holder is so constructed as to allow variation of the relative spatial arrangement of the four spindles disposed in parallel relationship, it is possible to conform the multi-format spindle transport device according to the invention to substrates of most different outer contour. This is in particular of interest in connection with the production of optically readable business cards which oftentimes have a non-symmetric configuration. Examples of frequently processed formats include CDs of a thickness of 1.2 mm and a diameter of 120 mm or 80 mm, DVDs of a thickness of 0.6 mm and a diameter of 120 mm or 80 mm, as well as optically readable business cards of a thickness of 1.2 mm and dimensions of 85×58 mm², 85×60.8 mm², 86×60 mm², 80×60 mm², 3.5″×2.5″, whereby the shorter sides may have an arcuate configuration. Of course, any other formats are conceivable, for example those with an equilateral triangle having a side length of same magnitude.

In order to suit the spindle transport device to varying substrate formats, at least one spindle is adjustable relative to the other spindles and is fixably supported. Advantageously, two spindles can be respectively combined to a pair in fixed spaced-apart relationship and adjustably supported relative to the other pair. Of course, it is also possible to individually position all spindles.

It has been shown especially advantageous to configure the device according to the invention such that both spindle pairs can be disposed symmetrically to a vertical symmetry plane of the spindle holder.

According to another feature of the present invention, the spindle holder includes at least one front plate and a back plate as well as spindle carriers for support of respectively two spindles. Front and back plates can be securely arranged on a base plate.

According to another feature of the present invention, each spindle carrier can be made of two parts, having a forward part and a rearward part. Ball bearings may be provided for support of the spindles.

The spindle carriers may be swingably supported about at least one longitudinal axis in parallel relationship to the longitudinal spindle axis, preferably however about two such axes. Part of the spindle holder may include pivot arms on which the spindle carriers are respectively swingably supported about a first axis and which in turn are swingable about a second axis. Advantageously, the pivot arms are also made of two parts, with a forward pivot arm being connected to the forward part of the spindle carrier and with a rearward pivot arm being connected to the rearward part of the spindle carrier.

The pivot axes for both spindle carriers may be realized by shafts which extend at least along the length of the spindles in parallel relationship thereto. The shafts are supported on their front and rear sides in parts of the spindle holder. The shaft, which represents the pivot axis of the spindle carrier relative to both pivot arms supporting it, is hereby only connected with the spindle carrier. The other shaft about which the pivot arms swing is also provided for support of the pivot arms upon the front and back plates of the spindle holder.

According to another feature of the present invention, a locking mechanism may be provided for securing the spindle carrier in the position in which the just processed substrates are in engagement with all four spindles. In this way, the device can be adjusted firmly to the desired substrate format.

The spindle carriers can be secured by clamping sleeves, for example, which are arranged about shafts attached in coaxial relationship to the pivot axes. In cooperation with appropriate bracing means like screws, the shafts are braced securely by the clamping sleeves with the front and back plates of the spindle holder and the pivot arms. Markings may be applied on the spindle holder, the spindle carriers and the pivot arms to simplify the relative position for certain frequently processed substrate formats. It is of advantage to select a respective mirror symmetrical adjustment to a vertical length plane of the spindle transport device for both corresponding spindle pairs. So long as the processed substrates are in engagement with all four spindles, a non-symmetrical alignment is, however, also conceivable.

Preferably provided for rotating the spindles is a servomotor which drives all spindles in synchronism. The motor is supported on the spindle holder. Toothed belts are advantageously used for motion transmission and are typically provided on only one, preferably the forward side of the spindle holder whereas the spindles are only rotatably supported on the backside of the holder.

According to another feature of the present invention, each spindle carrier may have a first toothed belt pulley which propels via a toothed belt the spindle pair disposed in the spindle carrier. This first toothed belt pulley in turn can be driven by a second toothed belt which is in mesh with a second toothed belt pulley. The rotation axes of both toothed belt pulleys are preferably configured in coaxial relationship to the pivot axes of the spindle carrier and the pivot arm. Suitably, the toothed belt pulleys are supported directly on both shafts which are attached along the pivot axes. The second toothed belt runs preferably along the respective forward pivot arm on which the spindle carrier is supported. It may, however, also be fitted inside this pivot arm. A third toothed belt driven by the shaft of the servomotor propels both second toothed belt pulleys.

During transport of circular substrates with the multi-format spindle transport device according to the invention, the substrates rotate about their own rotation axis. This rotation movement is caused by friction to which the substrates are exposed as a result of their placement on the thread root of the rotating spindles. In case of circular substrates, the rotation movement ensures an even cooling and less edge stress.

On the other hand, when non-circular substrates are involved, the rotation movement forced upon the substrate as a consequence of the contact with the thread root of the transport spindles is undesired because it may cause the substrates between the spindles to be pushed up and subsequently tilt. As a result, the transport is interrupted, and the substrates may become damaged. Therefore, the transport of substrates of non-circular outer contour advantageously involves the use of an anti-rotation mechanism.

According to another feature of the present invention, the anti-rotation mechanism can be constructed to act from below onto the substrates and to lift them slightly so as to be still in engagement with all transport spindles but no longer resting on the base of the spindle threads. As a result, friction between substrate and spindle is minimized and the forced rotation movement is prevented.

Lifting the substrates may take place either in midsection, or advantageously the provision of two strips is desired which extend upon the length of the spindles along the shafts which represent the pivot axes of the spindle carriers about the pivot arms. According to a preferred embodiment, the strips are so configured as to enclose the shafts. A clamping mechanism is used to adjust the strips in such a manner as to slightly lift the substrates from the spindle base while the substrates maintain engagement with the threaded spindle turns.

It may, however, also be sufficient to lift the substrates on only one side. In this case, a strip is attached only on this side.

According to another feature of the present invention, the spindles may be provided with at least two thread turns of different width so that substrates with at least two different thicknesses can be transported by the spindle transport device according to the invention, such as, e.g., CDs and DVDs.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a front view of an embodiment of a multi-format spindle transport device according to the invention;

FIGS. 2, 3 are schematic sectional views of a spindle transport device according to FIG. 1 for two different optically readable business card formats and with two different variants of an anti-rotation mechanism;

FIG. 4 is a partly sectional view of another variant of an anti-rotation mechanism; and

FIG. 4a is a schematic illustration of still another variant of an anti-rotation mechanism.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

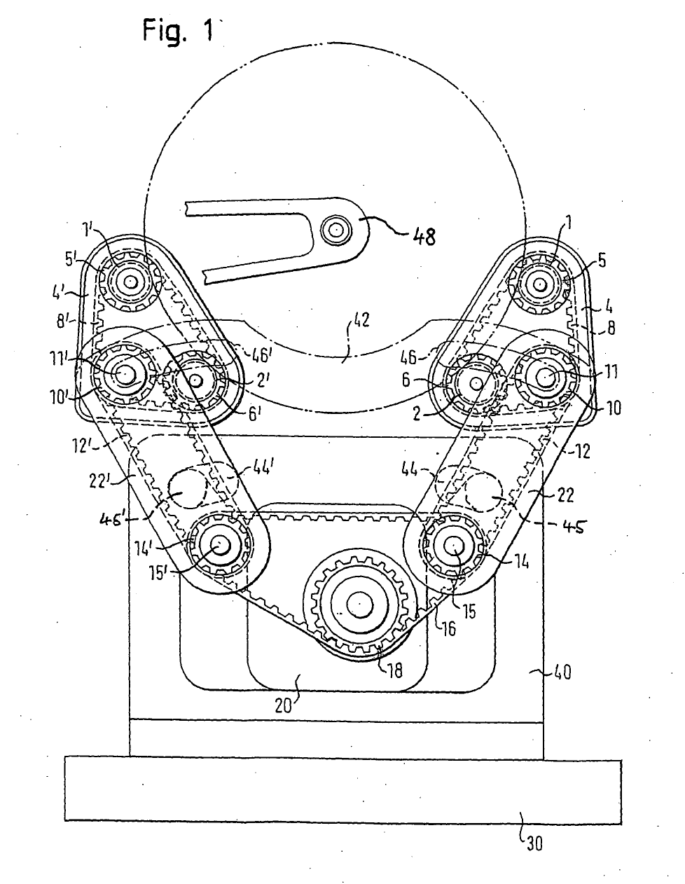

Turning now to the drawing, and in particular to FIG. 1, there is shown a front view of an embodiment of a multi-format spindle transport device according to the invention. Mounted on a base plate 30 are a supporting attachment plate 40 and a front plate 42, illustrated by dashdot lines. A back plate corresponding to the front plate is not shown.

The following description of the spindle transport device according to the invention is made in detail only in relation to the right side. The description is however applicable in analog manner for corresponding parts on the left side for which primed reference characters are used.

Secured to the attachment plate 40 is a servomotor 20, with a pivot arm 22 being supported on the lower end of the attachment plate for pivoting about a shaft 15. The shaft 15 connects the front plate 42 and the attachment plate 40 of the spindle transport device with the back plate. The pivot arm includes a forward pivot arm 22 and an unillustrated rearward pivot arm which is supported on the back plate for pivoting about the shaft 15 and extends parallel to the forward pivot arm 22. Both these pivot arms are connected at their other end by a further shaft 11 via which a spindle carrier 4 is swingably supported on the pivot arms. The pivot arms are guided in the front plate and analogous in the back plate via pins 45 and the shaft 11, respectively, in oblong holes 44 and 46 which extend on arcuate sections about the shaft 15. In this way, the pivot movement about the shaft 15 is stabilized and the pivot angle of the pivot arms is restricted to a reasonable degree.

The spindle carrier 4 as well as the pivot arm 22 are made of two parts and include a forward part, visible in FIG. 1, and a rearward part, not visible. Two parallel threaded spindles 1 and 2 are rotatably supported in their end points at a fixed relative distance in the forward and rearward parts of the spindle carrier 4. The spindles 1, 2 are supported by ball bearings in the spindle carriers 4. The length axes of the spindles 1, 2 do not correspond with the pivot axis of the spindle carrier 4 which pivot axis is in coincidence with the shaft 11. On the side facing the front plate 42, the spindles 1, 2 are fixedly connected with toothed belt pulleys 5, 6. The toothed belt pulleys 5, 6 are in engagement with a first toothed belt pulley 10 via a toothed belt 8 which is routed within the forward part of the spindle carrier 4. This first toothed belt pulley 10 runs on the shaft 11 about which also the pivot movement of the spindle carrier 4 relative to the pivot arm 22 takes place. The first toothed belt pulley 10 interacts via a further toothed belt 12 with a second toothed belt pulley 14. The second toothed belt pulley 14 runs on the shaft 15, representing at the same time the pivot axis for the pivot movements of the pivot arm 22, and is connected by a further toothed pulley 16 with the toothed belt pulley 18 propelled by the shaft of the servomotor 20. This toothed belt 16 drives both spindle pairs 1, 2; 1′, 2′ of the spindle transport device according to the invention in synchronism.

In order to secure during operation the position of the spindle pairs 1, 2; 1′, 2′ with respect to the just processed substrate format, unillustrated clamping sleeves are provided about the shafts 11, 15. These clamping sleeves extend along the entire length of the shafts 11, 15 between the forward and rearward parts of the pivot arm 22 and interact with further also unillustrated locking means such as, for example, thumb screws or shim rings which are provided on the outer side of the front and back plates and the pivot arm, respectively. In this way, the pivot arm 22, which is swingably supported on the shaft 15, can be locked relative to the front plate 42, and the spindle carrier 4, which is swingably supported on the shaft 11, can be locked relative to the pivot arm 22.

The spindles 1, 2; 1′, 2′ are configured preferably at least double-threaded, with thread turns of different thickness being provided. One of the threads may receive substrates of a thickness of 1.2 mm and a second one substrates of a thickness of 0.6 mm.

FIG. 1 shows a CD or DVD by way of dashdot line in engagement with the thread turns of all spindles 1, 2; 1′, 2′. The adjustment of the respective pivot arms 22, 22′ and the spindle carriers 4, 4′ in symmetry to a vertical length plane of the spindle transport device according to the invention is visible. The circular substrate rests evenly in all thread turns upon the thread root. Thus, as the spindles rotate the substrate also rotates during operation about its rotation axis as a result of friction between the substrate and the spindle base, and cools down in an especially uniform manner.

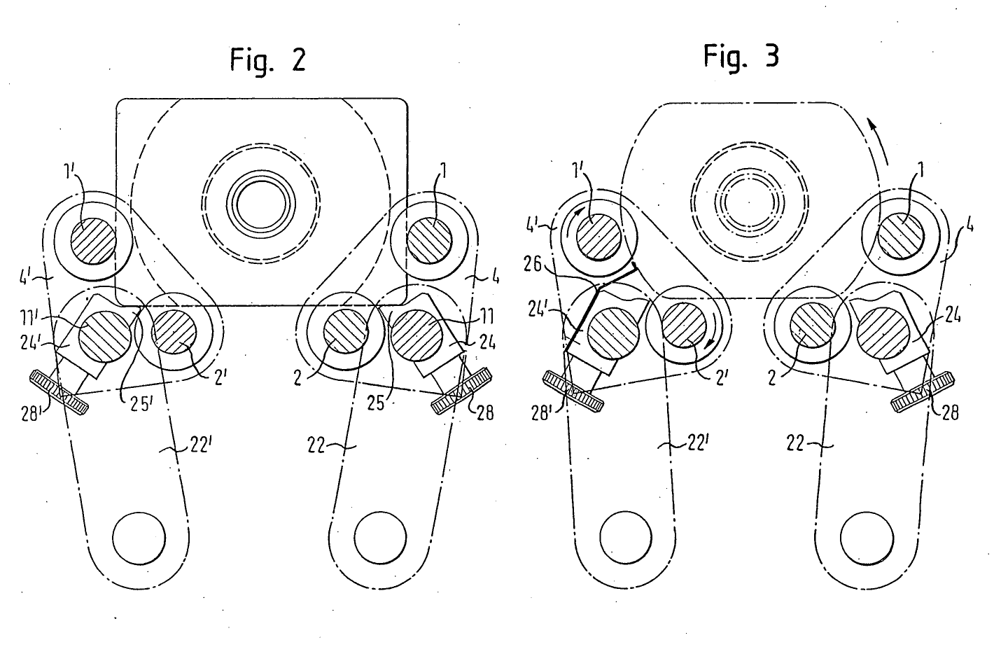

FIGS. 2 and 3 show schematic illustrations through a spindle transport device according to the invention, with two different formats of non-circular substrates being received in the thread turns of the spindles 1, 2. Corresponding parts are again labeled with primed reference characters. In order to suit the device to other formats and to ensure that the substrate are in engagement with the thread turns of all spindles, the pivot arms 22 are adjusted steeper than shown in FIG. 1 and the spindle carriers 4 are laterally pivoted to a greater degree.

When non-circular substrates are involved, there is the risk that the substrates are pushed up perpendicular to the transport direction as a result of the forced rotation movement in the transport device caused by friction between substrate and thread root of the spindles, i.e. are moved out of the even engagement with all spindles, and may get damaged. To prevent this, the provision of an anti-rotation mechanism is required. In FIG. 2, a strip 24 acts as anti-rotation mechanism. The strip embraces the shaft 11, about which the spindle carriers 4, 4′ are swingably supported, and extends along the entire length of the spindles 1, 2. A knurled screw 28 secures and adjusts the strip 24 on the shaft 11. In the present embodiment, the strip 24 has a nose 25. The strip 24 is so adjusted that the substrate rests on the nose 25 during transport along the spindles 1, 2 and thus is slightly lifted from the spindle base of the subjacent spindle 2, while still engaging the thread turns of the spindle 2.

FIG. 3 shows a further conventional format of optically readable business cards in engagement with the spindles of the spindle transport device according to the invention, which uses an alternative variation of the anti-rotation mechanism. The strip 24 is further equipped with an additional rail 26 which again extends along the entire length of the spindles and provides a contact surface for the substrates. As a result, substantially rectangular substrate formats may also be processed having narrow sides of arcuate configuration. As shown here, it is indeed sufficient to provide only one anti-rotation mechanism on one side of the spindle transport device. However, the side should be selected in relation to the spindle rotation direction, as indicated by the arrow in FIG. 3.

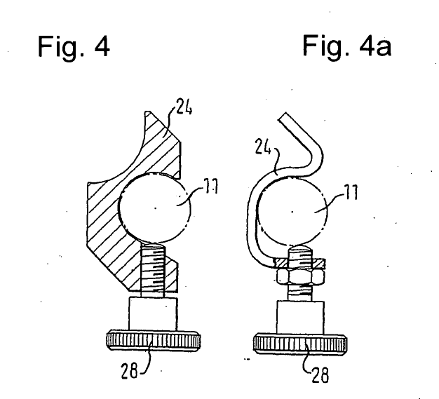

FIGS. 4 and 4a shows a detailed view of two possible configurations of a strip 24 acting as anti-rotation mechanism and secured by a clamping mechanism. The advantage of a securement through clamping resides in the possibility of a rapid installation to a spindle transport device according to the invention, when the operation is changed from circular substrates to substantially rectangular business card formats.

At operation, a newly produced substrate is removed by a known extraction device, for example a pivot arm 48 with gripper from a mold of an injection molding machine and placed from atop into the spindle threads of the spindle transport device according to the invention as provided for the concerned substrate thickness. The spindles must hereby be positioned with the assistance of a position sensor by the servomotor 20 in such a manner that the respective spindle threads are readied for receiving the substrate in the depositing position. As soon as the substrate has been deposited, the servomotor 20 drives the spindles 1, 1′, 2, 2′ via the toothed belts 16, 12, 12′, 8, 8′ in synchronism, and the deposited substrate is transported along the transport path. When a further substrate should be deposited, the spindles are halted in a position in which the substrate can be placed into the matching thread turns. As soon as a substrate has reached the end of the transport path, the servomotor 20 is stopped and the substrate is removed by a further known extraction device from the spindle transport device for subsequent processing.

In order to suit the spindle transport device to a different substrate format, the locking means on the shafts 15, 15′ and 11, 11′, respectively, are loosened, the pivot arms 22, 22′ and the spindle carriers 4, 4′ are pivoted into the new desired positions and again tightened. The new position is characterized preferably by a mirror-symmetric alignment of the pivot arms 22, 22′ and spindle carriers 4, 4′. The substrates must be in engagement with all spindles, and the anti-rotation mechanism for non-circular substrate formats must be additionally adjusted such that the substrates are prevented from resting on the thread roots of the subjacent spindles 2, 2′. To facilitate the adjustment of the pivot arm position and spindle carrier position for typical substrate formats, position markings may be provided on the spindle holder, the spindle carriers 4, 4′ as well as the pivot arms 22, 22′.

Assurance must be made however for each adjustment that the transport device is freely accessible from atop for loading.

The multi-format spindle transport device according to the invention allows transport of flat substrates of varying outer contours and cooling at the same time. Conforming to new substrate formats can easily be realized.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A multi-format spindle transport device for transporting and cooling flat substrates, in particular optically readable data carriers, comprising:
a spindle holder;
four spindles disposed in the spindle holder in parallel relationship; and
a drive for rotating the spindles,
wherein the spindle holder is constructed to allow adjustment of a relative spatial arrangement of the spindles relative to one another such that substrates of varying formats can be brought into engagement with all four spindles at a same time.

2. The multi-format spindle transport device of claim 1, wherein at least one of the spindles is mounted detachably in the spindle holder for adjustment relative to the other spindles.

3. The multi-format spindle transport device of claim 1, wherein the spindles are divided in two pairs of two spindles, with the two spindles of each pair arranged at a fixed distance relative to one another and adjustably supported relative to the other pair of spindles.

4. The multi-format spindle transport device of claim 3, wherein the two spindle pairs are arranged in symmetry relative to a vertical plane of the spindle holder.

5. The multi-format spindle transport device of claim 1, wherein the spindle holder includes a front plate and a back plate.

6. The multi-format spindle transport device of claim 3, wherein the spindle holder includes spindle carriers, one of the spindle carriers supporting one of the spindle pairs, and another one of the spindle carriers supporting the other one of the spindle pairs.

7. The multi-format spindle transport device of claim 6, wherein the spindle carriers are made of two parts with a forward part and a rearward part.

8. The multi-format spindle transport device of claim 6, wherein the spindle carriers are swingably supported about at least one length axis in parallel relationship to a longitudinal spindle axis.

9. The multi-format spindle transport device of claim 8, wherein the spindle carriers are swingably supported about two different length axes.

10. The multi-format spindle transport device of claim 9, wherein the spindle holder includes pivot arms for rotatable support of the spindle carriers about a first axis, said pivot arms being swingably mounted about a second axis.

11. The multi-format spindle transport device of claim 8, wherein the spindle holder has shafts to define pivot axes for both spindle pairs, said shafts extending at least along a length of the spindles.

12. The multi-format spindle transport device of claim 6, and further comprising a locking means for securing the spindle carriers in place.

13. The multi-format spindle transport device of claim 12, wherein the locking means includes clamping sleeves which are securable on the shafts and braceable against front and back plates of the spindle holder.

14. The multi-format spindle transport device of claim 1, wherein the drive includes a servomotor to rotatably drive the spindles.

15. The multi-format spindle transport device of claim 14, wherein the drive includes toothed belts operatively connected to the servomotor for driving the spindles.

16. The multi-format spindle transport device of claim 6, wherein the drive includes a servomotor and toothed belts operatively connected to the servomotor for driving the spindles, with the one spindle carrier having attached thereon a toothed belt pulley which is in engagement via one of the toothed belts with the one of the spindle pairs, and with the other one spindle carrier having attached thereon a toothed belt pulley which is in engagement via another one of the toothed belts with the other one of the spindle pairs.

17. The multi-format spindle transport device of claim 16, wherein the toothed belt pulley of each spindle carrier is driven by a further toothed belt which is looped about a further toothed belt pulley.

18. The multi-format spindle transport device of claim 17, wherein the toothed belt pulleys of the spindle carriers and the further toothed belt pulleys rotate about rotation axes in coaxial relationship to a pivot axis of the spindle carriers.

19. The multi-format spindle transport device of claim 16, and further comprising another one of the toothed belts via which the servomotor drives the further toothed belt pulleys.

20. The multi-format spindle transport device of claim 1, and further comprising an anti-rotation mechanism for preventing a rotation of a non-circular substrate.

21. The multi-format spindle transport device of claim 20, wherein the anti-rotation mechanism is constructed to act substantially from below on the non-circular substrate.

22. The multi-format spindle transport device of one of the claims 20, wherein the anti-rotation mechanism includes at least one strip which extends substantially along a length of the spindles and is constructed to support the non-circular substrate.

23. The multi-format spindle transport device of claim 22, and further comprising a clamping mechanism for adjusting the strip.

24. The multi-format spindle transport device of claim 22, wherein the spindle holder includes spindle carriers swingably mounted on shafts and supporting the spindle pairs, said strip being attached on one of the shafts.

25. The multi-format spindle transport device of claim 22, wherein the strip is provided on one side of the spindle holder.

26. The multi-format spindle transport device of claim 1, wherein the spindles have each at least two thread turns with differently wide thread undercuts to be able to receive substrates of different thickness.
